(19) United States
(12) Patent Application Publication
(10) Pub. No.: US 2018/0209271 A1
(43) Pub. Date: Jul. 26, 2018

(54) AN INTELLIGENT VACUUM PUMP WITH LOW POWER CONSUMPTION

(71) Applicant: PADMINI VNA MECHATRONICS PVT. LTD., Gurgaon (IN)

(72) Inventors: KABIR BHANDARI, Gurgaon (IN); RAJESH KUMAR SAHOO, Gurgaon (IN); PRAVEEN GUPTA, Gurgaon (IN); SUMIT RAJPAL, Gurgaon (IN)

(73) Assignee: PADMINI VNA MECHATRONICS PVT. LTD., Gurgaon (IN)

(21) Appl. No.: 15/327,481

(22) PCT Filed: Jul. 19, 2015
(86) PCT No.: PCT/IB2015/055471

§ 371 Date: Jan. 19, 2017

(30) Foreign Application Priority Data
Jul. 19, 2014 (IN) 2048/DEL/2014

(51) Int. Cl. F01C 21/08; F04C 18/344; F04C 25/02; F04C 28/06; F04C 29/02; B60T 17/02

(52) U.S. Cl. CPC F01C 21/0845; F04C 18/3441; F04C 25/02; B60T 17/02; F01C 21/0881; F04C 29/021; F04C 28/06

(57) ABSTRACT

A vacuum pump for automobiles used for brake application is provided wherein a method of reducing power consumption and running torque in a vacuum pump of a motor vehicle is explained. The present invention also provides a vacuum pump for automobiles comprising an actuator, a new vane locking assembly, a new vane and rotor assembly, a new non return valve assembly, the controlled oil supply means and a reed stopper assembly that reduces power loss and unnecessary frictional forces and to maintain a controlled oil supply to the vacuum pump.

### FIELD OF THE INVENTION

The present invention relates to an intelligent vacuum pump controlling apparatus for automobiles braking system. More particularly, this invention relates to a method of reducing power consumption and running torque in a vacuum pump of automobiles. The present invention also provides a vane locking mechanism to reduce power loss and regulate oil supply to the vacuum pump to prevent additional power losses due to continuous oil supply.

### BACKGROUND OF THE INVENTION

Brakes are mechanical devices which increase the frictional resistance that retards the rotational motion of the wheels. However, in automobiles vacuum assisted hydraulic brake system is utilized to generate a constant vacuum in the brake booster by the engine for easy application of greater resistance to the wheel.

In general, the brake system in an automobile comprises of a brake pedal, a power brake booster, a master cylinder, hydraulic lines, wheel cylinder and disc brakes and/or drum brakes. A vacuum pump is present in the brake system to provide the vacuum power that provides maximum output resistance with minimum mechanical input. The vacuum pump is activated continuously when the engine is running and creates a vacuum to the power break booster. Power brake boosters provide the pneumatic boosting to enhance the force from the brake pedal by utilizing the pressure difference between the vacuum chamber and the working chamber. The generated force pushes the disc brakes and/or drum brakes to generate an adequate braking torque for the vehicles.

One of the main advantages of using the vacuum brake system in a motor vehicle is to provide the required force at the brakes of a motor vehicle. When a driver presses the brake pedal they get assistance from the braking system without which the driver has to provide greater resistance i.e. a user shall feel the brake pedal very hard so has to input greater force. Normally the pressure decreases in the brake booster when heavy braking is applied, which further causes a decrease in amplification during braking. This condition of low pressure in the brake booster during the condition of heavy braking is removed by using an auxiliary vacuum pump which can maintain, or even increase the amplification during a heavy braking phase.

During operation of the vacuum pump, oil is drawn from the oil reservoir into the feed valves by the vacuum generated by the pump. When the vacuum pump is in the pressure mode, the pressurized oil reservoir forces oil to the side feed valves and into the pump. The oil flow rate from the oil reservoir is controlled by the oil pump. After the booster attains the full vacuum, the pump still rotates and allows the oil flow in to the pump; in such cases the usual vacuum pump takes extra power from the engine. At the same time the oil pump in the engine also continuously supplies oil in to the vacuum pump which causes additional power loss.

German patent No. 27 16 471 discloses a brake system of this type wherein a compressed air pump can be connected to a high pressure chamber of a brake power booster by way of an electrically operable solenoid valve. The pressure in the high pressure chamber is adjusted by way of a pulsed electric actuation of the solenoid valve. A low pressure chamber is directly connected to a vacuum pump.

A disadvantage of this known brake system is the use of a solenoid valve which is complicated and costly and requires an electric or electronic controlling or regulating unit for the actuation. The compressed air pump as well as the vacuum pump is constantly in operation which maintains the maximum possible excess pressure or vacuum. This results in high energy consumption as the full pump rate is provided while operating the braking system.

Therefore, the object of the present invention is to overcome unnecessary energy loses and provide a durable, cost effective and energy saving braking device and system.

U.S. Pat. No. 2,240,792 disclosed the self-adjustment concept of brakes to automatically maintain a constant clearance between the surfaces of the friction material and the brake drum when the brakes are released, to automatically compensate for the wearing off of these surfaces. A self adjustment means and thermostatic means are disclosed to compensate the wear due to friction and to compensate for the heat resulting from the frictional elements. The fluid pressure adjustment is provided to compensate the friction means.

Conventional vacuum braking system suffers the problem of overheating due to improper oil flow rate and friction. For the reliability of the vacuum braking system more accurate vacuum pressure system is needed.

Therefore, there is a need for a reliable and efficient vacuum pump system which reduces the power loss in the ideal working condition i.e. when vacuum is reached in a break booster tank to a desired value then actuator moves the shaft in downward direction which causes the disengagement of the vanes in-to the housing wall and cuts or minimizes the oil supply in to the pump. This causes the reduction of frictional losses between the vane tip and the housing wall. In addition to this the oil supply is stopped or minimized which causes low power consumption in oil pump. This causes low torque to operate the pump and causes low power consumption. The oil flow regulation can be done through various ways like using tapper sleeve, actuating rod, sleeve with groove or any kind of other mechanical/electrical controlling device and which can be actuated forward or backward through vacuum, pressure, oil pressure regulator valve, Solenoid valve etc. or any other actuating method.

### OBJECT OF THE INVENTION

The main object of this invention is to provide an improved configuration of a vacuum pump in the motor control apparatus of a motor vehicle.

Yet another object of this invention is to provide an improved vacuum pump in the motor control apparatus of a motor vehicle, which consumes less power.

Yet another object of this invention is to provide a novel vane locking mechanism for reduction of frictional losses between the vane tip and the housing wall, additionally maintaining a controlled oil supply causing low power consumption in oil pump.

Yet another object of this invention is to reduce the premature wear of the vane of a vacuum pump.

Yet another object of this invention is to provide an improved vacuum pump having less axial force due to the incoming oil on the rotor.

Yet another object of this invention is to provide an optimized oil supply in to the pump which reduces the oil pump efforts and results low power consumption.

Yet another object of this invention is to provide a method of reducing power consumption and running torque in a vacuum pump of a motor vehicle.

Yet another object of this invention is to provide an improved vacuum pump having less friction between the vane and the housing.

Yet another object of this invention is to reduce the friction between the vane and rotor during full vacuum condition.

Yet another object of this invention is to provide an improved vacuum pump to reduce the peak force at the maximum compression point.

### SUMMARY OF THE INVENTION

The present invention relates to an improved vacuum pump of a motor vehicle. The invention provides for a method of reducing power consumption and running torque in the vacuum pump of a motor vehicle. The improved configuration of vacuum pump results into lesser friction loss by implementing the new feature for oil management, friction management within the vacuum pump assembly.

In one aspect of the present invention, provides a vacuum pump for automobiles comprising an actuator assembly of a diaphragm, a spring and a movable vertical shaft, connecting a break booster tank and a oil supply path; a new vane locking assembly; a new vane and rotor assembly ; a new non return valve assembly; the controlled oil supply means; and a reed stopper assembly; wherein: the actuator assembly having stepped diameter with a leaner diameter at the tip and a preceding broader diameter; the vane locking assembly, further comprising a plurality of stoppers resting on a plurality of disc springs, a plurality of vane locking adaptors connected to a plurality of extension springs such that the assembly engaging the shaft on actuation, the shaft having a stepped diameter, the initial lower diameter is engaged in vane locking but as the shaft moves further downwards under actuation, the broader diameter engages in vane locking and causes said plurality of vanes locking adaptors to move outwards and strike with the plurality of vanes to block movement due to force applied by the plurality of disc springs thereby reducing power loss and regulate controlled oil supply to the vacuum pump to prevent additional power loss due to continuous oil supply; the vane and rotor assembly, further comprising a housing connecting the engine, receiving oil from oil gallery and supporting: a Knob connecting the Engine Camshaft and transmitting Power and Torque to Vacuum Pump; a rotor causing the movement of the vane in rotary and reciprocating motion; a locking Cap restricting movement of the rotor in the axial direction preventing the knob to come out from the rotor; and vane tip sweeping the air and oil by making closed chamber; the non-return valve (NRV) assembly further comprising a inlet connector, a diaphragm, a spring and a spring retainer wherein said diaphragm is resting on said inlet connector through the action of said spring which is supported by said spring retainer allowing the air in one direction only; the controlled oil supply means provides an optimized oil flow rate upon achieving a desired vacuum state in the brake booster tank; and the reed stopper assembly further comprising Sealing Reed, Reed Stopper and Spring Washer, screwed on Housing to allow oil exit and prevents air leakage.

A method of reducing power loss and regulate controlled oil supply to the vacuum pump for automobiles to prevent additional power loss due to continuous oil supply via vane locking mechanism, the method comprising the steps of: activating actuator by achieving a desired vacuum is reached in the brake booster tank that pushes the diaphragm into downward direction; that allows the spring to compress and the shaft starts moving into downward direction, due to stepped diameter of the shaft; engaging vane locking assembly to initially engage the lower diameter as the shaft move in downward direction; and further engaging the larger diameter in vane locking and causing said plurality of vane locking adaptors to move into outward direction that strike with the plurality of vanes to block movement due to force applied by the plurality of disc springs.

The present invention utilizes the combined effects of less friction between the vane slider and the housing and optimized oil flow rate from the pressurized oil reservoir which results in less power consumption and running torque in more efficient and effective way over the existing vacuum pumps.

Various general and specific objects and advantages of the invention will become apparent when reference is made to the following description of the invention considered in conjunction with the related drawings.

### BRIEF DESCRIPTION OF THE DRAWINGS

A complete understanding of the system and method of the present invention may be obtained by reference to the following drawings:

FIG. 1 is an exploded view of a conventional vacuum pump.

FIG. 2 is a diagrammatic view of a vacuum pump according to the present invention.

FIG. 3a is a plan view of a conventional rotor assembly.

FIG. 3b is a plan of a rotor assembly according to the present invention.

FIG. 4 is a plan view of the vane locking sub assembly according to the one embodiment of the present invention.

FIG. 5 is a top view of a vane locking assembly according to the one embodiment of the present invention.

FIG. 6 is a side view of a rotor according to another embodiment of the present invention wherein an oil passage groove is provided on the wall of the rotor.

FIG. 7 is a top view of the rotor according to the present invention wherein the double slot for vane and an oil passage groove is provided in the center of the rotor as well.

FIG. 8 is a top view of the vane and rotor assembly.

FIG. 9 is a plan view of the Non Return Valve (NRV) assembly.

FIG. 10 is a plan view of the reed stopper assembly.

FIG. 11 is a plan view of the vacuum pump.

FIG. 12 is a diagrammatic representation of the vane locking mechanism.

FIG. 13 is a comparative graph to show percent reduction in torque between conventional vacuum pump and novel vacuum pump according to the current invention.

### DESCRIPTION OF THE PREFERRED EMBODIMENTS

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

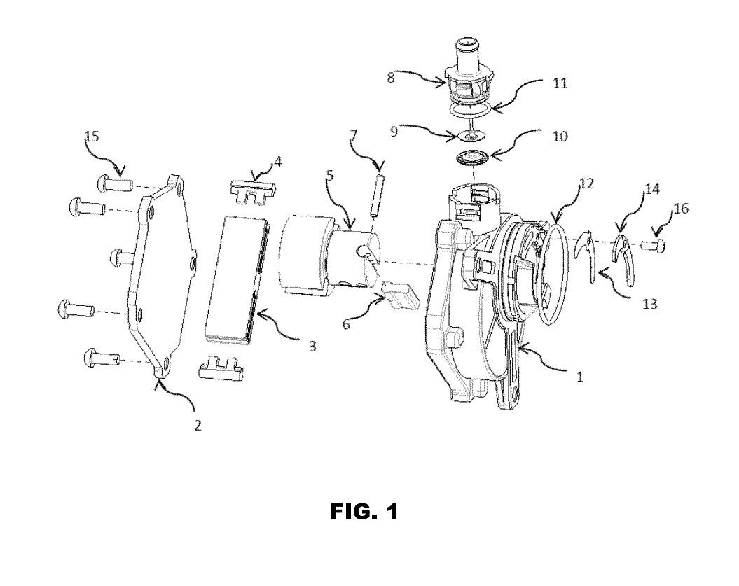

FIG. 1 is an exploded view of conventional vacuum pump. The vacuum pump comprises a casing 1 provided with a rotor 5 and a vane 3. The vane 3 having vane slider 4 is slidably supported in a recess of the rotor 5. The Housing 1, rotor 5, vane 3 and vane slider 4 enclosed with the cover 2 and form the pump chamber. The sealing ring 12 adapted, in use, to provide a seal against the engine cylinder head. In the embodiment shown the rotor 5 is circular and the recess bisects the rotor 5. The rotor 5 is positioned in the casing 1 such that rotational axis thereof lies on a plane of symmetry of the casing 1. The rotor 5 is positioned on this plane such that the edge of the rotor 5 almost touches the casing 1. In the arrangement shown, the rotor can be said to be positioned in an upper portion of the casing 1. The aforementioned plane of symmetry extends between top centre and bottom centre of the casing 1.

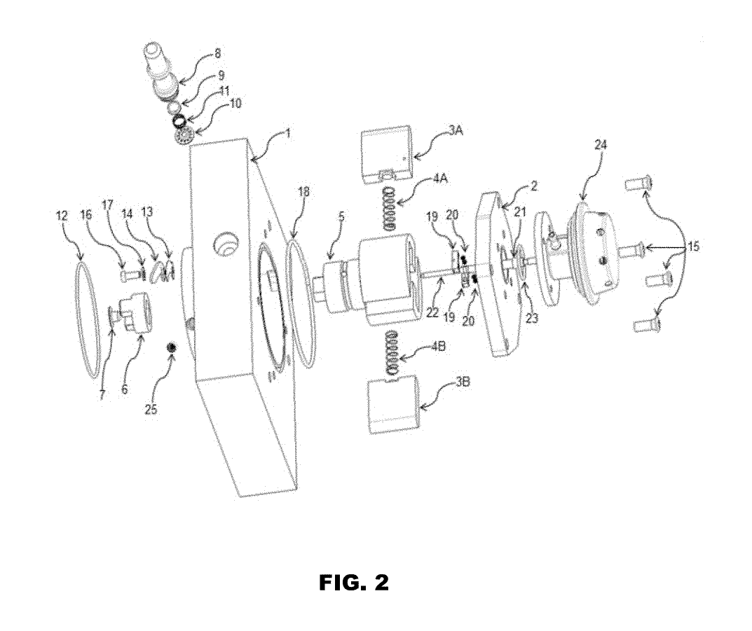

FIG. 2 is a diagrammatic view of a vacuum pump according to the present invention. Housing 1 is assembled with a rotor 5 and an actuator 24 operated with an external actuation system. Housing 1 is connected to an engine and receives oil from the oil gallery. It supports all child parts and having profile. Knob 6 is connected with the engine camshaft and transmits power and torque to vacuum pump. In other words, it enables the rotor 5 to rotate as camshaft rotates. The locking cap 7 restricts the knob 6 to move in axial direction and in this way; it prevents the knob 6 to come out from the rotor 5.

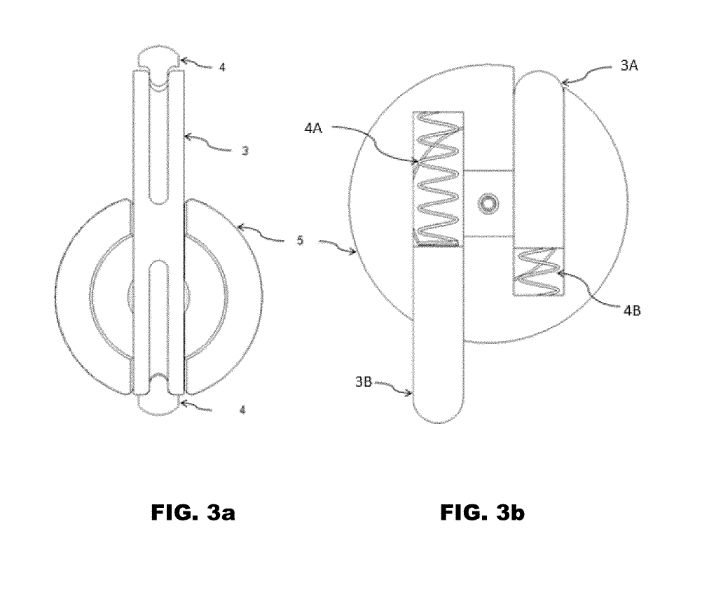

FIG. 3a is a plan view of a conventional rotor assembly wherein a single vane 3 is provided with a plurality of vane sliders 4.

FIG. 3b is a plan view of a rotor assembly according to the present invention wherein the rotor 5 is provided with plurality of vanes 3A, 3B connected to compressible spring vanes 4A and 4B.

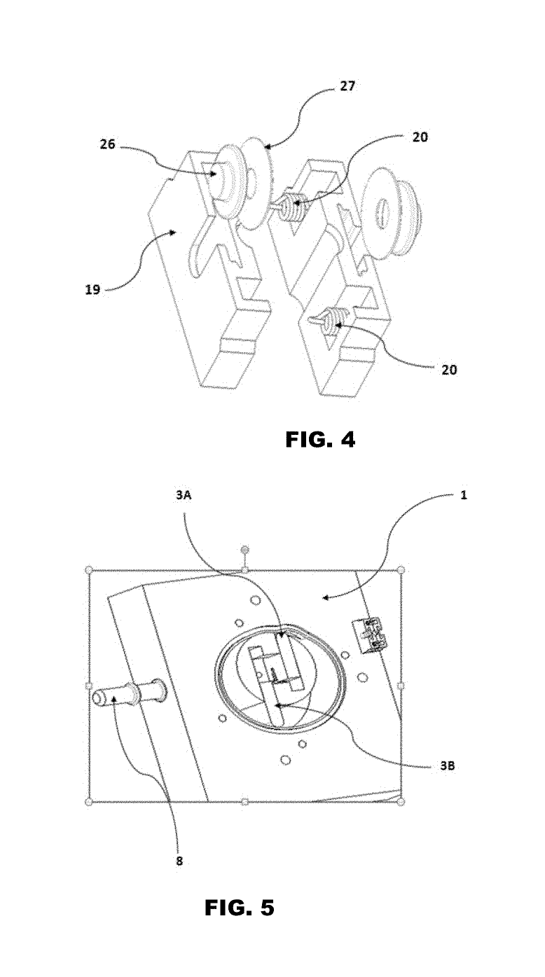

FIG. 4 is a plan view of the vane locking sub assembly which consists of a plurality of vane locking adaptors 19, a plurality of disc springs 27, a stopper 26, and an extension type spring 20.

FIG. 5 is a top view of vane blocking assembly that encloses the vane locking sub-assembly and assembled in rotor 5 through dove tail joint.

FIG. 6 is a side view of a rotor according to another embodiment of the present invention wherein an oil passage groove is provided on the wall of the rotor.

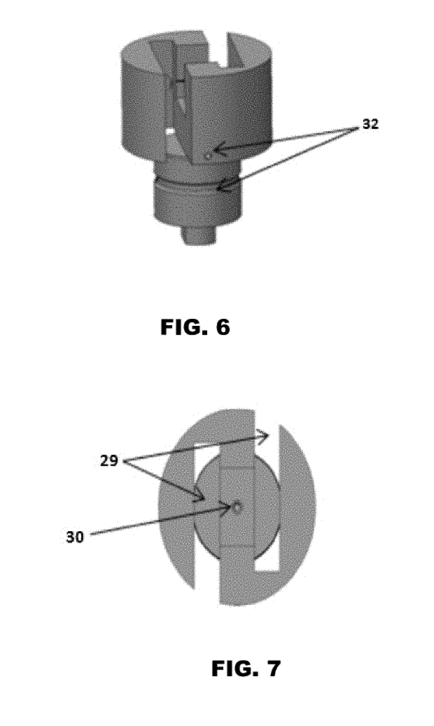

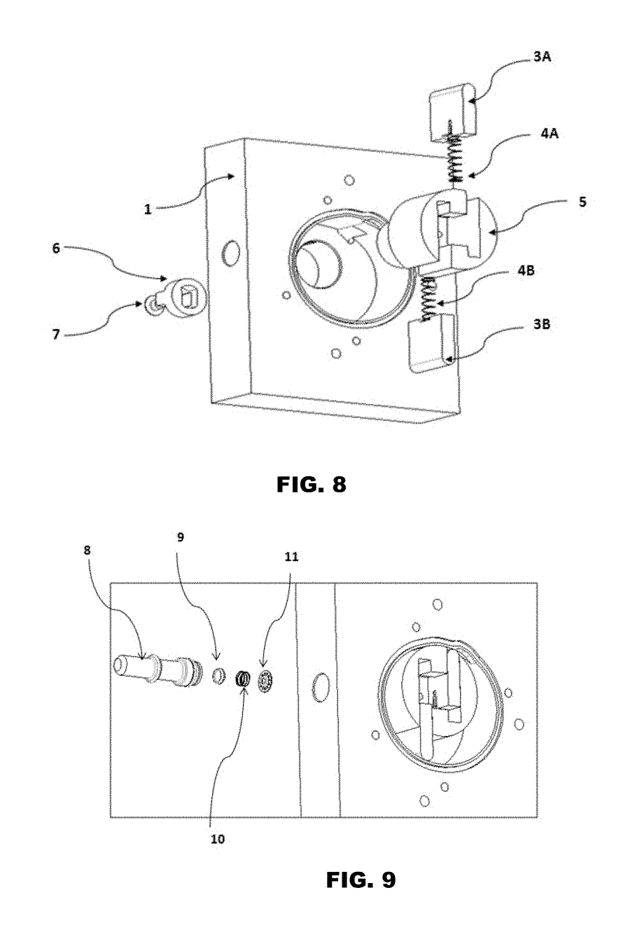

FIG. 7 is a top view of the rotor according to the present invention wherein the double slot for vane and an oil passage groove is provided in the center of the rotor as well.

FIG. 8 is a top view of the vane and rotor assembly comprising the housing 1, wherein rotor 5 is assembled through journal bearing and it rotates by the help of Knob 6 which is fixed in rotor 5 by locking cap 7. Vanes 3A, 3B are fitted in the rotor 5 by sliding fit with the aid of spring vanes 4A, 4B such that the reciprocation motion of vanes 3A, 3B can be achieved through cam mechanism of hosing profile.

FIG. 9 is a plan view of the Non Return Valve (NRV) assembly comprising of inlet connector 8, diaphragm 9, spring 10, and spring retainer 11. Diaphragm 9 is resting on inlet connector 8, through the action of spring 10 which is supported by spring retainer 11.

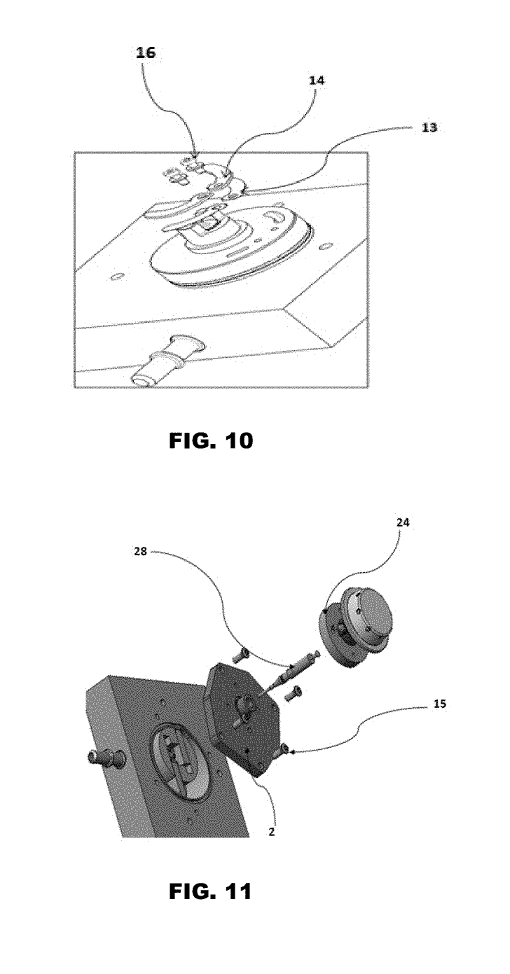

FIG. 10 is a plan view of the reed stopper assembly wherein sealing reed 13 is rest on the housing 1 and reed stopper 14 provides support for sealing reed 13. All parts are fastened by M4 screw 16.

FIG. 11 is a plan view of the vacuum pump wherein cover 2 is assembled by four numbers of M6 screw 15 and actuator 24 is assembled in the shaft 28.

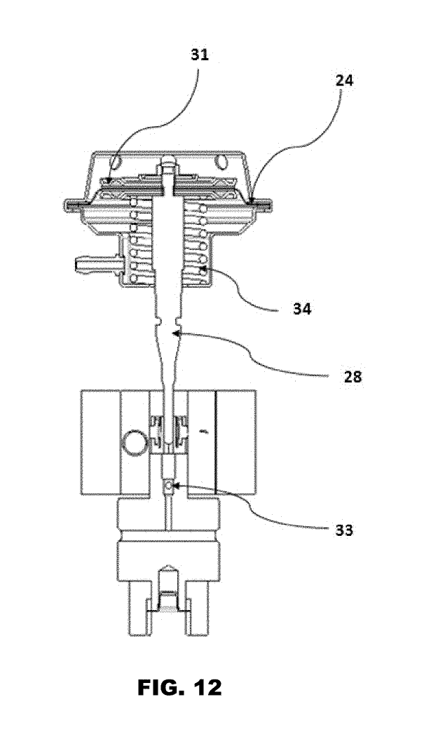

FIG. 12 represents the vane locking mechanism wherein the actuator 24 is connected to break booster Tank. In actuator 24 there is assembly of diaphragm 31 and spring 34.

Once, the actuator 24 gets actuated through an external actuation system and the brake booster tank achieves full vacuum, the actuator 24 starts moving downwards that pushes the diaphragm 31 into downward direction; that allows spring 34 to compress and at the same time the shaft 28 also starts moving downwards wherein the shaft is having a stepped diameter with a leaner diameter at the tip and a preceding broader diameter. Due to stepped diameter of the shaft 28, initially leaner diameter is engaged in vane locking but as the shaft 28 moves in downward direction the preceding broader diameter engages in vane locking and causes said plurality of vanes locking adaptors 19 to move outwards and strike with the plurality of vanes 3A, 3B to block movement due to force applied by the plurality of disc springs 27.

The external actuation system includes: a pneumatic method i.e. pressure or vacuum, an electrical actuation method, oil regulated actuator means or any other method which get signal from the break booster.

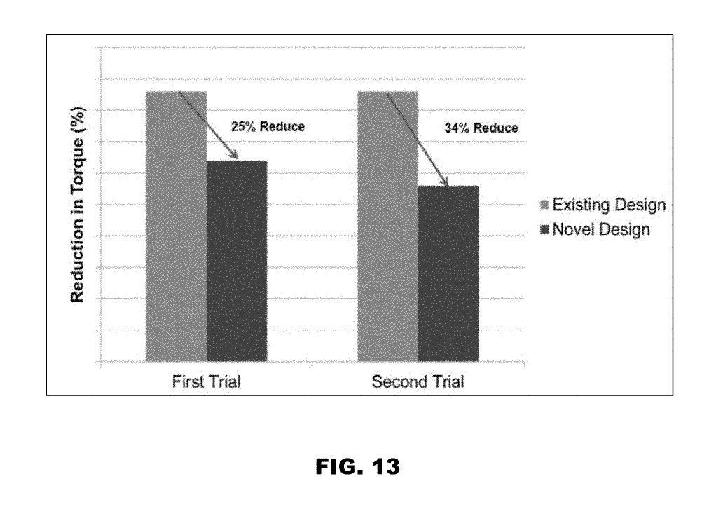

FIG. 13 is a comparative graph to show percent reduction in torque between conventional vacuum pump and novel vacuum pump according to the current invention. Two trials are conducted to compare performance of existing design and novel design of the vacuum pump according to the present invention and percent reduction in torque required for braking is noticed. It is surprisingly observed that the novel design of the vacuum pump reduces power consumption as a measure of 25-34% reduction of applied torque.

In an embodiment a method of reducing power loss and regulate controlled oil supply to the vacuum pump for automobiles to prevent additional power loss due to continuous oil supply via vane locking mechanism, the method comprising the steps of: activating actuator by achieving a desired vacuum in the brake booster tank that pushes the diaphragm in downward direction; that allows the spring to compress and the shaft starts moving into downward direction, due to stepped diameter of the shaft; engaging vane locking assembly to initially engage the lower diameter as the shaft moves in downward direction; and further engaging the larger diameter in vane locking and causing said plurality of vane locking adaptors to move into outward direction that strike with the plurality of vanes to block movement due to force applied by the plurality of disc springs. The desired vacuum pressure is in the range of 96 Kpa±5 (720 mmHg).

As shown in figures, the present invention utilizes the combined effects of less friction between the vane and the housing and optimized oil flow rate from the pressurized oil reservoir which results in less power consumption and running torque in more efficient and effective way over the existing vacuum pumps.

While the best mode has been described in detail, those familiar with the art will recognize various alternative designs and examples within the scope of the following claims.

We claim:

1. A vacuum pump for automobiles comprising
an actuator assembly of a diaphragm, a spring and a movable vertical shaft, connecting to a break booster tank and a oil supply path;
a new vane locking assembly;
a new vane and rotor assembly;
a new non return valve assembly (NRV);
the controlled oil supply means; and
a reed stopper assembly;
wherein:
the actuator assembly having stepped diameter with a leaner diameter at the tip and a preceding broader diameter;
the vane locking assembly, further comprising a plurality of stoppers resting on a plurality of disc springs, a plurality of vane locking adaptors connected to a plurality of extension springs such that the assembly engaging the shaft on actuation, the shaft having a stepped diameter, the initial lower diameter is engaged in vane locking but as the shaft moves further downwards under actuation, the broader diameter engages in vane locking and causes said plurality of vanes locking adaptors to move outwards and strike with the plurality of vanes to block movement of the shaft due to force applied by the plurality of disc springs thereby reducing power loss and regulate controlled oil supply to the vacuum pump to prevent additional power loss due to continuous oil supply;
the vane and rotor assembly, further comprising a housing connecting the engine, receiving oil from oil gallery and supporting: a Knob connecting the Engine Camshaft and transmitting Power and Torque to Vacuum Pump; a rotor causing the movement of the vane in rotary and reciprocating motion; a locking Cap restricting movement of the rotor in the axial direction preventing the knob to come out from the rotor; and vane tip sweeping the air and oil by making closed chamber;
the non-return valve (NRV) assembly further comprising a inlet connector, a diaphragm, a spring and a spring retainer wherein said diaphragm is resting on said inlet connector through the action of said spring which is supported by said spring retainer allowing the air in one direction only;
the controlled oil supply means provides an optimized oil flow rate upon achieving a desired vacuum state in the brake booster tank; and
the reed stopper assembly further comprising Sealing Reed, Reed Stopper and Spring Washer, screwed on Housing to allow oil exit and prevents air leakage.

2. The vacuum pump for automobiles as claimed in claim 1, wherein the actuator on actuation moves the diaphragm and spring assembly driving the shaft downwards under suction and interrupts the oil supply path.

3. The vacuum pump for automobiles as claimed in claim 1, wherein the actuator retracts the shaft when Vacuum in Break Booster Tank maintain below the desired level.

4. The vacuum pump for automobiles as claimed in claim 1, wherein said external actuation system is actuated by pneumatic method, an electrical actuation method, a means of oil regulated actuator or any other method which get signal from the break booster.

5. The vacuum pump for automobiles as claimed in claim 1, wherein the controlled oil supply means is provided by oil inlet orifice and the actuator shaft.

6. The vacuum pump for automobiles as claimed in claim 1, wherein the power consumption is reduced to 25-34% of applied torque.

7. A method of reducing power loss and regulate controlled oil supply to the vacuum pump for automobiles to prevent additional power loss due to continuous oil supply via vane locking mechanism, the method comprising the steps of:
activating actuator by achieving a desired vacuum in the brake booster tank that pushes the diaphragm in downward direction; that allows the spring to compress and the shaft starts moving into downward direction, due to stepped diameter of the shaft;
engaging vane locking assembly to initially engage the lower diameter as the shaft moves in downward direction; and
further engaging the larger diameter in vane locking and causing said plurality of vane locking adaptors to move into outward direction that strike with the plurality of vanes to block movement due to force applied by the plurality of disc springs.

8. The method as claimed in claim 7, wherein desired vacuum pressure is in the range of 96 Kpa±5 (720 mmHg).

9. The method as claimed in claim 7, wherein said shaft moves in downward direction and strikes in rotor oil hole to block the oil supply.

10. The method as claimed in claim 7, wherein said vane locking mechanism is vacuum dependent.
